(19) United States
(12) Patent Application Publication
(10) Pub. No.: US 2023/0294480 A1
(43) Pub. Date: Sep. 21, 2023

(54) DEVICES, SYSTEMS, AND VEHICLES FOR PROVIDING HEATING, VENTILATION, AND AIR CONDITIONING (HVAC) FUNCTIONS

(71) Applicant: Rivian IP Holdings, LLC, Plymouth, MI (US)

(72) Inventors: Danny Jierian, Diamond Bar, CA (US); Graham Lloyd Feltham, Garden City, MI (US); Kamalesh Bhambare, Novi, MI (US)

(21) Appl. No.: 17/696,946

(22) Filed: Mar. 17, 2022

(51) Int. Cl. B60H 1/00; B60H 1/24

(52) U.S. Cl. CPC B60H 1/00864; B60H 1/00564; B60H 1/00664; B60H 1/246; B60H 1/247; B60H 2001/00721

(57) ABSTRACT

Various disclosed embodiments include illustrative door assemblies, vehicles, and methods of assembling door assemblies. In an illustrative embodiment, a seat includes a base section, a back section, a first section of duct, and one or more vents couplable to the first section of duct. The first section of duct is configured to receive air from an air supply source and the first section of duct is disposed at least partially within the base section. The one or more vents are disposed at an aft surface of a section chosen from the base section and the back section.

### INTRODUCTION

The present disclosure relates to a climate control system. The statements in this section merely provide background information related to the present disclosure and may not constitute prior art.

HVAC ducting throughout vehicle is currently limited by space within interior trim components, such as in the center console or body pillars. However, the interior trim components house various other components thereby limiting usage of the interior trim space.

### BRIEF SUMMARY

Various disclosed embodiments include illustrative door assemblies, vehicles, and methods of assembling door assemblies

In an illustrative embodiment, a seat includes a base section, a back section, a first section of duct, and one or more vents couplable to the first section of duct. The first section of duct is configured to receive air from an air supply source and the first section of duct is disposed at least partially within the base section. The one or more vents are disposed at an aft surface of a section chosen from the base section and the back section.

In another illustrative embodiment, a system includes an air supply source, a first section of duct configured to receive air from the air supply source, and one or more vents couplable to the first section of duct. The first section of duct is disposed at least partially within a base section of a seat. The one or more vents are disposed at an aft surface of the seat.

In another illustrative embodiment, a vehicle includes a cabin, an air supply source, a user interface device, a controller configured to communicate with the user interface and the air supply source, a memory configured to communicate with the controller, and a seat slidably received within the cabin. The memory is configured to store computer-executable instructions configured to cause the controller to control operation of the air supply source responsive to signals received from the user interface device. The seat includes a base section, a back section, a first section of duct configured to receive air from the air supply source, and one or more vents couplable to the first section of duct. The first section of duct is disposed at least partially within the base section. The one or more vents are disposed in an aft surface of a section chosen from the base section and the back section.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a perspective, partial x-ray view of an illustrative vehicle with a heating, ventilation, and air conditioning (HVAC) system.

FIG. 2 is a block diagram of an illustrative HVAC system used in the vehicle of FIG. 1.

FIG. 3 is a perspective, x-ray view of a seat used in the vehicle of FIG. 1.

FIG. 4 is a cross-sectional view of a portion of the HVAC system located within the seat of FIG. 3.

FIG. 5 is a perspective view of a portion of seats used in the vehicle of FIG. 1.

FIG. 6 is a perspective, x-ray view of another seat used in the vehicle of FIG. 1.

FIG. 7 is a cross-sectional view of a portion of the HVAC system located within the seat of FIG. 6.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative devices, systems, and vehicles for providing heating, ventilation, and air conditioning (HVAC) functions in an enclosed cabin.

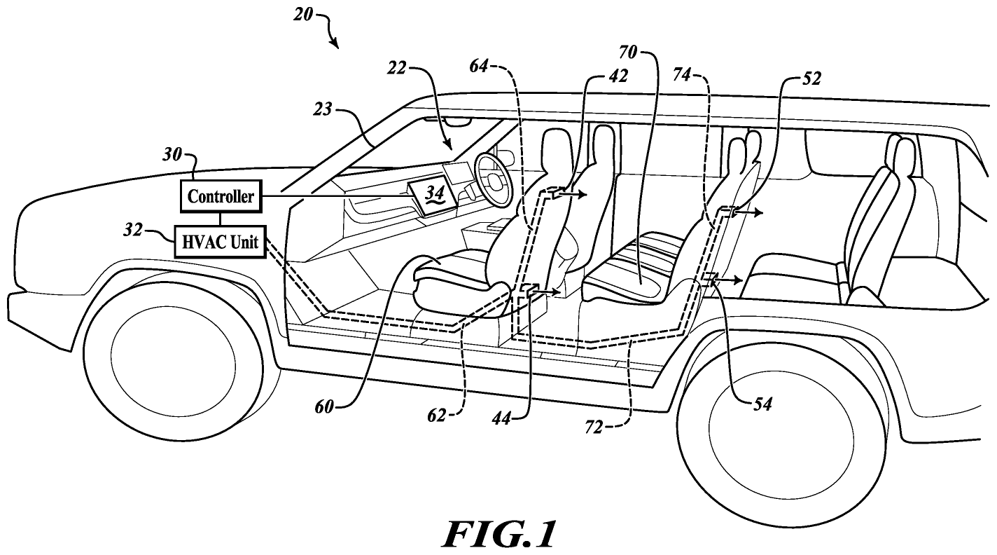

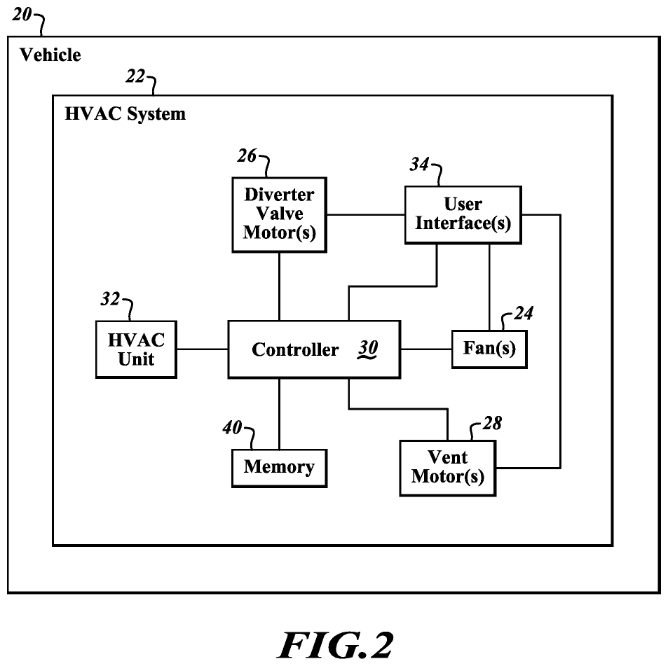

Given by way of non-limiting overview and referring to FIGS. 1 and 2, in various embodiments, an illustrative vehicle 20 includes a cabin 23, and a cabin air distribution unit (a heating, ventilation, and air conditioning (HVAC) system 22) dispersed within the cabin 23 and other sections of the vehicle 20 for heating, cooling, and ventilating the cabin 23. The HVAC system 22 may include an air supply source, such as, without limitation, an HVAC unit 32, a user interface device(s) 34, a controller 30, and a seat, such as, without limitation, a first seat(s) 60 and a second seat(s) 70. The controller 30 communicates with the user interface device(s) 34 and the HVAC unit 32. The seats 60 and 70 may slide, tilt, and be raised or lowered within the cabin 23. The first seat(s) 60 of the first row includes a base section 61, a back section 63, a first section of duct 62, and one or more vents 42 and 44. The first section of duct 62 is coupled to the HVAC unit 32. The first section of duct 62 is configured to receive air from the HVAC unit 32 and is disposed at least partially within the base section 61 and partially under a floor of the cabin 23. The first section of duct 62 attaches to the HVAC unit 32 in an engine compartment or other ducting that extends from the HVAC unit 32. The vents 42 and 44 are attached to the first section of duct 62. A first vent 42 is disposed in an aft surface of the back section 63 and a second vent 44 is disposed in an aft surface of the base section 61 or at a lower part of the back section 63. Also, the vehicle 20 includes the second seat 70 in a second row of seats located distal from the first seat 60 of the first row. The second seat 70 includes a second section of duct 72 that attaches to the first section of duct 62 and one or more vents 52 and 54 that are attached to the second section of duct 72. The second section of duct 72 is disposed at least partially within a base section of the second seat 70 and partially under a floor of the cabin 23. The vents 42, 44, 52, and 54 may be located at various other locations of the seats 60 and 70.

In the illustrative embodiment, air supplied by the HVAC unit 32 passes through the first seat 60 via the duct 62 to the vents 42 and 44 on the back of the first seat 60 to provide air to occupants in a second row of seats including the second seat 70. Also, air supplied by the duct 62 of the first seat 60 passes through the second seat 70 via the duct 72 to the vents 52 and 54 on the back of the seat 70 to provide air to occupants/area behind the second seat 70, such as a third row of seats.

Given by way of non-limiting example, in various embodiments the vehicle 20 may include a motor vehicle driven by wheels and/or tracks, such as, without limitation, an automobile, a truck, a sport utility vehicle (SUV), a van, and the like. Given by way of further non-limiting examples, in various embodiments the vehicle 20 may include a marine vessel such as, without limitation, a boat, a ship, a submarine, a submersible, an autonomous underwater vehicle (AUV), and the like. Given by way of further non-limiting examples, in various embodiments the vehicle 20 may include an aircraft such as, without limitation, a fixed wing aircraft, a rotary wing aircraft, and a lighter-than-air (LTA) craft. In various embodiments, an enclosed cabin may be used in place of the vehicle 20. The cabin need not be mobile like the vehicle 20, but includes an HVAC system for heating, cooling, and ventilating the space within the cabin having at least one row of seats.

Given by way of non-limiting example, in various embodiments the HVAC unit 32 includes a heat exchanger, a blower motor, an evaporator coil, and a thermostat. HVAC systems are well known in the art and no further explanation is necessary for a person of skill in the art to understand disclosed subject matter.

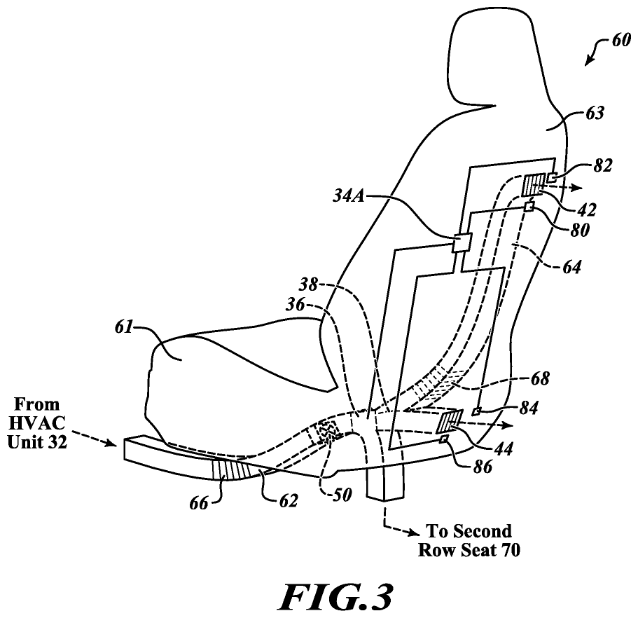

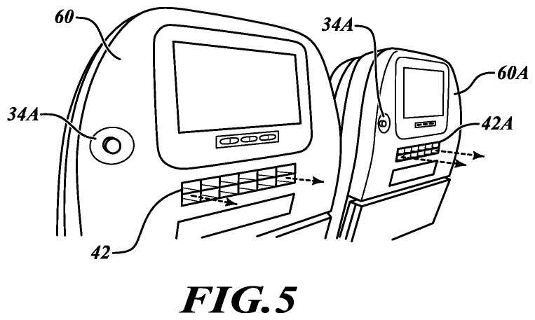

As shown in FIG. 2, in various embodiments, the vehicle 20 includes the HVAC system 22 having various electrically-driven components. Other physical components of the HVAC system 22 are shown and described in more detail below in FIGS. 3-7. The HVAC system 22 may include the controller 30 that is in an electrical/signal communication with the user interface device(s) 34, a memory 40, an optional fan(s) 24, the HVAC unit 32, an optional vent motor(s) 28, and an optional diverter valve motor(s) 26. The controller 30 receives instructions/signals from the user interface device(s) 34 and processes those instructions/signals. The memory 40 is configured to store computer-executable instructions configured to cause the controller 30 to provide control signals to various other components of the HVAC system 22, such as, without limitation, the fan(s) 24, the HVAC unit 32, the vent motor(s) 28, and the diverter valve motor(s) 26. The instructions/signals may include heating, venting, and/or cooling requests from a user. Responsive to the instructions/signals, the controller 30 sends a command instruction(s) to the HVAC unit 32, the fan(s) 24, the vent motor(s) 28, and/or the diverter valve motor(s) 26, accordingly. The user interface device(s) 34 may directly control operations of the fan(s) 24, the diverter valve motor(s) 26, and/or the vent motor(s) 28, as will be described in more detail below.

In various embodiments and given by way of example only and not of limitation, the user interface device(s) 34 may include mechanical buttons, switches, voice recognition capabilities, gesture recognition capabilities, or may include selectable graphical user interface features presented on a vehicle display device(s) or via an application program executable by a person electronic device. The user interface device(s) 34 allows a vehicle operator to select heating, venting, and/or cooling operational modes for the cabin 23 or various portions of the cabin 23. The user interface device(s) 34 may also include control switches located on or near the seats 60 and 70. The control switches are configured to activate the fan(s) 24, the vent motor(s) 28 and/or the diverter valve motor(s) 26.

As shown in FIGS. 3-5, in various embodiments, the illustrative first seat 60 includes the base section 61, the back section 63, the first section of duct 62, the first vent 42, and the second vent 44. The first section of duct 62 receives air from the HVAC unit 32. The first section of duct 62 is disposed at least partially within the base section 61, the floor of the cabin 23, and a firewalled compartment, such as, without limitation, an engine compartment, where the HVAC unit 32 and other components are located. The vents 42 and 44 are coupled to the first section of duct 62 and are disposed at an aft surface of the base section 61 and/or the back section 63.

In various embodiments, the first seat 60 includes a flow control device(s), such as, without, limitations, louvers of the vents 42 and 44 or diverter valves 36 and 38. The flow control device(s) may have manual controls or may include motors, such as, without limitation, vent motors 80, 82, 84, 86 and diverter valve motors 90 and 92. The vent motors 80, 82, 84, 86 and the diverter valve motors 90 and 92 may be an electrical servomotor or comparable devices.

In various embodiments, the diverter valve motors 90 and 92 may be located on the outside of the first diverter valve 36 with a shaft extending into the first diverter valve 36 to make rotary contact with the diverter valves 36 and 38. The diverter valves 36 and 38 may also be attached to manual levers located external to the diverter valves 36 and 38 that are easily accessible to an operator of vehicle 20 while sitting in the first seat 60. In the illustrative embodiment, the first diverter valve 36 may be a rotary vane valve and the second diverter valve 38 may be a flapper valve. The first diverter valve 36 and/or the second diverter valve 38 may include other types of diverter valves. Diverter valves are well known in the art and no further explanation is necessary for a person of skill in the art to understand disclosed subject matter.

In various embodiments, the first vent 42 is a face vent having one or more louvers. The louvers of the first vent 42 and the second vent 44 may be manually controlled or may be controlled by the vent motors 80, 82, 84, and 86, respectively. The first vent 42 is disposed in the back section 63, such that the louvers allow for the up and down and/or side to side control of air exiting the first vent 42. The louvers of the first vent 42 may be controlled to direct air at passengers' faces and/or upper bodies for those passengers who are seated in the second row of seats 70 located immediately behind the first row of first seats 60.

In various embodiments, the second vent 44 is a foot vent having one or more louvers. The second vent 44 is disposed at a lower half or third of the back section 63 or at the aft surface of the base section 61, such that the louvers allow for the up and down and/or side to side control of air exiting the second vent 44. The louvers of the second vent 44 may be controlled to direct air at passengers' feet and/or lower body portions for those passengers who are seated in the second row of seats 70 located immediately behind the first row of first seats 60.

In various embodiments, as shown in FIGS. 3-5, the first seat 60 includes a user interface device 34A and a fan 50 disposed in the first section of duct 62. The fan 50 is configured to cause movement of air responsive to a signal received from the controller 30 and/or the user interface device 34A. The user interface device 34A a may also be used to control operations of the vent motors 80, 82, 84, and 86 and the diverter valve motors 90 and 92. The controller 16 may also provide control signals for controlling operations of the vent motors 80, 82, 84, and 86, the diverter valve motors 90 and 92, and/or the fan 50.

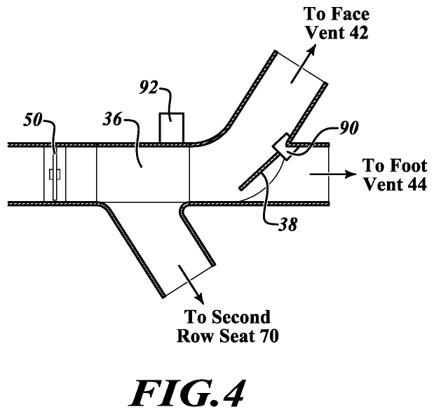

As shown in FIGS. 3 and 4, in various embodiments, the illustrative first section of duct 62 may include an expandable base section 66, the first diverter valve 36, the second diverter valve 38, and a first vent section of duct 64 having an expandable and/or flexible vertical section 68. The expandable base section 66 is disposed proximal from the first diverter valve 36. As the first seat 60 and/or the base section 61 is moved either manually or by seat motors proximally and distally within the cabin 43, the expandable base section 66 expands or compresses thereby maintaining the connections and reducing stress on the components. As the back section 63 is tilted either manually or by seat motors, the flexible vertical section 68 expands or compresses, thereby maintaining the connections and reducing stress on the components.

In various embodiments, still referring to FIG. 4, the first diverter valve 36 is disposed proximal from the second diverter valve 38. The first diverter valve 36 may be a rotary vane valve that is rotatably attached to a shaft that passes through the first section of duct 62. The first diverter valve 36 may be positioned to direct air coming from first section of duct 62 to pass only to the second diverter valve 38 or a section of duct that leads to the second seat 70, or simultaneously to the second diverter valve 38 or the section of duct that leads to the second seat 70. The first diverter valve 36 may be attached to the diverter valve motor 92 configured to receive instructions from the controller 30 or the user interface devices 34 and 34A.

In various embodiments, still referring to FIG. 4, the second diverter valve 38 is disposed proximal from the first vent section of duct 64 and a section of duct that leads to the second vent 44. The second diverter valve 38 may be a hinged flapper valve that is rotatably attached to an interior wall of the first section of duct 62. The second diverter valve 38 may be positioned to direct air coming from an inlet side of the second diverter valve 38 to pass only through the vertical section of duct 64 or the section of duct leading to the second vent 44, or simultaneously through both vertical section of duct 64 or the section of duct leading to the second vent 44. The second diverter valve 38 may be attached to the diverter valve motor 90 configured to receive instructions from the controller 30 or the interface devices 34 and 34A.

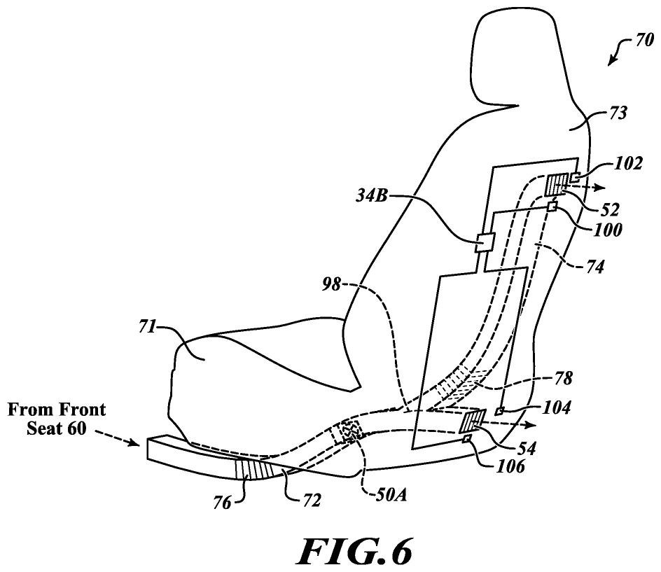

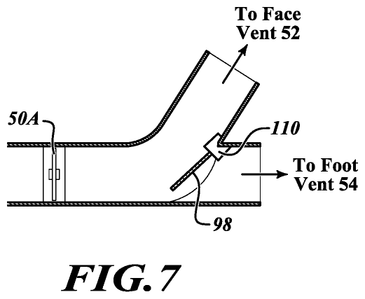

As shown in FIGS. 6 and 7, in various embodiments, the illustrative second seat 70 includes base section 71, a back section 73, the second section of duct 72, the third vent 52, and the forth vent 54. The second section of duct 72 receives air from the HVAC unit 32 via the first second of duct 62 and the first diverter valve 36. The second section of duct 72 is disposed at least partially within the base section 71, the floor of the cabin 23, and the base section 61 of the first seat 60. The third and fourth vents 52 and 54 are coupled to the second section of duct 72 and are disposed at an aft surface of the base section 71 and/or the back section 73.

In various embodiments, the second seat 70 includes a flow control device(s), such as, without, limitations, louvers of the vents 52 and 54 or a diverter valve 98. The flow control device(s) may have manual controls or may include motors, such as, without limitation, vent motors 100, 102, 104, and 106 and a diverter valve motor 110. The vent motors 100, 102, 104, and 106 and the diverter valve motor 110 may be an electrical servomotor or comparable devices.

In various embodiments, the diverter valve motor 110 may be located on the outside of the second section of duct 72 with a shaft extending into the second section of duct 72 to make rotary contact with the diverter valve 98. The diverter valve 98 may also be attached to a manual lever located external to the diverter valve 98 that is easily accessible to an operator of vehicle 20 while sitting in the seat 70. In the illustrative embodiment, the diverter valve 98 may be a rotary vane valve, a flapper valve, or other types of diverter valves.

In various embodiments, the third and fourth vents 52 and 54 include louvers and the vent motors 100, 102, 104, and 106 similar to the vents 42 and 44 in the first seat 60. The third vent 52 is disposed in the back section 73. The louvers of the third vent 52 may be controlled to direct air at passengers' faces and/or upper bodies for those passengers who are seated behind the second row of seats 70. The fourth vent 54 is disposed at a lower half or third of the back section 73 or at the aft surface of the base section 71, such that the louvers allow for the up and down and/or side to side control of air exiting the fourth vent 54. The louvers of the fourth vent 54 may be controlled to direct air at passengers' feet and/or lower body portions for those passengers who are seated behind the second row of seats 70.

In various embodiments, the second seat 70 may include a user interface device 34B and a fan 50A disposed in the second section of duct 72. The fan 50A is configured to cause movement of air responsive to a signal received from the controller 30, and/or the user interface device 34B. The user interface device 34B a may also be used to control operations of the vent motors 100, 102, 104, and 106 and the diverter valve motor 110. The controller 30 may also provide control signals for controlling operations of the vent motors 100, 102, 104, and 106 and/or the diverter valve motor 110.

As shown in FIG. 6, in various embodiments, the illustrative second section of duct 72 may include an expandable base section 76, the diverter valve 98, and a vent section of duct 74 having an expandable and/or flexible vertical section 78. The expandable base section 76 is disposed proximal from the diverter valve 98. As the second seat 70 and/or the base section 71 moves either manually or by seat motors proximally and distally within the cabin 43, the expandable base section 76 expands or compresses thereby maintaining the connections and reducing stress on the components. As the back section 73 is tilted either manually or by seat motors, the flexible vertical section 78 expands or compresses, thereby maintaining the connections and reducing stress on the components.

In various embodiments, the diverter valve 98 is disposed proximal from the vent section of duct 74 and a section of duct that leads to the fourth vent 54. The diverter valve 98 may be a hinged flapper valve that is rotatably attached to an interior wall of the second section of duct 72. The second diverter valve 98 may be positioned to direct air coming from an inlet side of the second diverter valve 98 to pass only through the vertical section of duct 74 or the section of duct leading to the fourth vent 54, or simultaneously through both vertical section of duct 74 or the section of duct leading to the fourth vent 54.

In various embodiments, a seat may include just the components for venting to an area behind the seat or just the components for passing air to ducting behind the seat within including any vents. The area that receives either the vented air or the duct from the seat may be other areas of the vehicle that are in need of venting, cooling, and/or heating, such as, without limitation, an inside or an outside sleeping area, a living area, a heating unit, a cooling unit (food/drink cooler), a work area, a storage area, or the like.

Those skilled in the art will recognize that at least a portion of the controller 30, the user interface device(s) 34, 34A, and 34B, components, devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interactive devices (e.g., a touch pad, a touch screen, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A seat comprising:
a base section;
a back section;
a first section of duct configured to receive air from an air supply source, wherein the first section of duct is disposed at least partially within the base section; and
one or more vents couplable to the first section of duct, wherein the one or more vents are disposed at an aft surface of a section chosen from the base section and the back section.

2. The seat of claim 1, wherein the one or more first vents includes:
a face vent disposed in the back section; and
a foot vent disposed in one of the base section or a lower third of the back section.

3. The seat of claim 1, wherein the one or more vents includes a flow control device chosen from louvers and a valve, the flow control device is configured to transition between allowing full airflow and no airflow.

4. The seat of claim 3, further comprising a user interface device,
wherein the flow control device includes one or more motors configured to control position of the louvers and the valve responsive to a signal received from a device chosen from a controller and the user interface device.

5. The seat of claim 1, wherein the first section of duct includes:
a proximal section;
a first distal section couplable to a first one of the one or more vents;
a second distal section couplable to a second one of the one or more vents; and
a diverter configured to cause air received from the proximal section to be diverted between the first distal section and the second distal section.

6. The seat of claim 5, further comprising:
a user interface device; and
a motor configured to control position of the diverter responsive to a signal received from a device chosen from a controller and the user interface device.

7. The seat of claim 1, further comprising:
a user interface device; and
a fan disposed in the first section of duct, wherein the fan is configured to cause movement of air responsive to a signal received from a device chosen from a controller and the user interface device.

8. The seat of claim 1, wherein the first section of duct includes:
a proximal section;
a distal section couplable to the one of the one or more vents; and
the seat further comprising:
a second section of duct;
a user interface device; and
a diverter disposed between the proximal section, the distal section, and the second section of duct, wherein the diverter is configured to cause air received from the proximal section to be diverted between the distal section and the second section of duct responsive to input from the user interface device.

9. A system comprising:
an air supply source; and
a first section of duct configured to receive air from the air supply source, wherein the first section of duct is disposed at least partially within a base section of a seat; and
one or more vents couplable to the first section of duct, wherein the one or more vents are disposed at an aft surface of the seat.

10. The system of claim 9, wherein the one or more first vents includes:
a face vent disposed in a back section of the seat; and
a foot vent disposed in one of a base section of the seat or a lower third of the back section.

11. The system of claim 9, wherein the one or more vents includes a flow control device chosen from louvers and a valve, the flow control device is configured to transition from between allowing full airflow and no airflow.

12. The system of claim 11, further comprising a user interface device,
wherein the flow control device includes one or more motors configured to control position of the louvers and the valve responsive to a signal received from a device chosen from a controller and the user interface device.

13. The system of claim 9, wherein the first section of duct includes:
a proximal section;
a first distal section couplable to a first one of the one or more vents;
a second distal section couplable to a second one of the one or more vents; and
a diverter configured to cause air received from the proximal section to be diverted between the first distal section and the second distal section.

14. The system of claim 13, further comprising:
a user interface device; and
a motor configured to control position of the diverter responsive to a signal received from a device chosen from a controller and the user interface device.

15. The system of claim 9, further comprising:
a user interface device; and
a fan disposed in the first section of duct, wherein the fan is configured to cause movement of air responsive to a signal received from a device chosen from a controller and the user interface device.

16. The system of claim 9, wherein the first section of duct includes:
a proximal section;
a distal section couplable to the one of the one or more vents;
the system further comprising:
a second section of duct;
a user interface device; and
a diverter disposed between the proximal section, the distal section, and the second section of duct, wherein the diverter is configured cause air received from the proximal section to be diverted between the distal section and the second section of duct responsive to input from the user interface device.

17. A vehicle comprising:
a cabin;
an air supply source;
a user interface device;
a controller configured to communicate with the user interface and the air supply source;
a memory configured to communicate with the controller, the memory configured to store computer-executable instructions configured to cause the controller to control operation of the air supply source responsive to signals received from the user interface device; and
a seat slidably received within the cabin, wherein the seat includes:
a base section;
a back section;
a first section of duct configured to receive air from the air supply source, wherein the first section of duct is disposed at least partially within the base section; and
one or more vents couplable to the first section of duct, wherein the one or more vents are disposed in an aft surface of a section chosen from the base section and the back section.

18. The vehicle of claim 17, wherein:
the first section of duct includes a proximal section, a first distal section, and a second distal section,
the seat further includes one or more diverters configured to cause air received in the proximal section to be diverted between the first distal section and the second distal section.

19. The vehicle of claim 18, wherein the seat further includes:
a motor configured to control position of the one or more diverters responsive to a signal received from a device chosen from the controller and the user interface device.
a fan disposed in the first section of duct, wherein the fan is configured to cause movement of air responsive to a signal received from a device chosen from the controller and the user interface device.

20. The vehicle of claim 17, wherein the first section of duct includes:
a proximal section;
a distal section couplable to one of the vents;
the vehicle further comprising:
a second section of duct;
a diverter disposed between the proximal section, the distal section, and the second section of duct, wherein the diverter is configured to divert air from the proximal section to the distal section and the second section of duct responsive to input from a device chosen from the controller and the user interface device;
a second seat including:
a second base section;
a second back section;
a third section of duct configured to receive air from the second section of duct, wherein the third section of duct is disposed at least partially within the second base section; and
one or more second vents couplable to the third section of duct, wherein the one or more second vents are disposed in an aft surface of a section chosen from the second base section and the second back section.
